(19) United States
(12) Patent Application Publication
(10) Pub. No.: US 2015/0228105 A1
(43) Pub. Date: Aug. 13, 2015

(54) Texture and Graphics Formation Techniques

(71) Applicant: Microsoft Corporation, Redmond, WA (US)

(72) Inventors: Richard Dean Harley, JR., Sammamish, WA (US); John Jacob Nelson, Redmond, WA (US)

(73) Assignee: Microsoft Corporation, Redmond, WA (US)

(21) Appl. No.: 14/178,632

(22) Filed: Feb. 12, 2014

(51) Int. Cl. G06T 15/04

(52) U.S. Cl. CPC G06T 15/04

(57) ABSTRACT

Texture and graphic formation techniques are described. In one or more implementations, an apparatus includes one or more modules implemented at least partially in hardware, the one or more modules configured to perform operations as part of a computing device. The apparatus also includes an outer layer disposed over and at least partially covering the one or more modules, the outer layer includes a graphics substrate having an outer surface that has a non-smooth texture and one or more graphics formed on an opposing side of the graphics substrate from the outer surface.

### BACKGROUND

The number and variety of configurations that may be employed by electronic and other devices, such as computing devices and accessory devices that are configured to add functionality the computing devices, is ever expanding. For example, mobile computing devices and other devices may be configured to be held and touched by one or more hands of a user. Consequently, a feel of these devices may become as important to users as a look of the device.

Accordingly, techniques have been developed to expand textures that may be available on these devices. However, conventional use of these textures typically restricted inclusion of graphics on parts of these device having that texture using conventional graphics application techniques. Thus, device manufacturers were often limited by these conventional techniques and forced to choose between inclusion of the graphic or a texture as part of the device.

### SUMMARY

Texture and graphic formation techniques are described. In one or more implementations, an apparatus includes one or more modules implemented at least partially in hardware, the one or more modules are configured to perform operations as part of a computing device. The apparatus also includes an outer layer disposed over and at least partially covering the one or more modules, the outer layer includes a graphics substrate having an outer surface that has a non-smooth texture and one or more graphics formed on an opposing side of the graphics substrate from the outer surface.

In one or more implementations, an input device includes a plurality of sensors configured to generate one or more inputs though user interaction, a connection portion, and an outer layer. The connection portion is configured to provide a physical and communicative coupling to a computing device, the communicative coupling configured to communicate the one or more inputs from the plurality of sensors to the computing device. The outer layer is configured to provide at least a portion of an outer surface of the input device, the outer layer includes a flexible graphics substrate having one or more graphics that are viewable through the flexible graphics substrate, the flexible graphics substrate is secured to a backer layer formed using a woven material.

In one or more implementations, a flexible material having graphics includes a graphics substrate having an outer surface having a non-smooth texture and the graphics formed on an opposing side of the graphics substrate from the outer surface and a backer layer formed from a flexible woven material that is secured to the graphics substrate using an adhesive such that the graphics substrate and the backer layer are flexible when secured to each other.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ the texture and graphics techniques described herein.

FIG. 2 depicts an example implementation of an input device of FIG. 1 as showing a flexible hinge in greater detail.

FIG. 3 depicts an example implementation showing a perspective view of a connection portion of FIG. 2 that includes mechanical coupling protrusions and a plurality of communication contacts.

FIG. 4 depicts an example implementation showing a cross section of the input device of FIG. 1.

FIG. 5 depicts an example implementation of a system usable to form a graphics substrate of an outer layer of FIG. 1.

FIG. 6 depicts an example implementation of a system usable to form graphics on the graphics substrate formed in FIG. 5.

FIG. 7 depicts an example implementation of a system usable to form a backer layer and adhesive of an outer layer of FIG. 1.

FIG. 8 depicts an example implementation of a system usable to form the outer layer of FIG. 1 using the graphics substrate having the printed graphics of FIG. 6 with the backer layer and adhesive of FIG. 7.

FIG. 9 depicts an example implementation showing a system usable to remove the release paper to expose an outer surface of the outer layer formed in FIG. 8.

FIG. 10 illustrates an example system generally at that includes an example computing device that is representative of one or more computing systems and/or devices that may implement the various techniques described herein.

### DETAILED DESCRIPTION

### Overview

The “look and feel” of devices has been and continues to be one of the primary differentiating factors in a consumer's choice regarding which option to choose from a variety of different devices. Consequently, manufacturers of these devices have developed techniques to include textures and other materials to distinguish their devices from one another. However, conventional techniques that are utilized to form the textures could limit inclusion of graphics on the textures and therefore in such an instance manufacturers using these conventional techniques could be forced to choose between look and feel in the design of and manufacture of the device.

Texture and graphics formation techniques are described. In one or more implementations, a flexible material is formed that is configured to include graphics and desired textures. The flexible material, for instance, may be formed by laminating a material (e.g., a polyurethane) onto a release paper to obtain a desired texture for use as a graphics substrate, such as to mimic a feel of fabric, leather, a woven material, and so on. Further, the other side of the graphics substrate may have a relatively smooth texture, e.g., as a result of the laminating. As such, graphics may then be printed on the side having the smooth texture in an efficient and accurate manner and thus overcome difficulties in conventional techniques that involved formation of graphics on a textured surface due to peaks and valleys that may be included on the textured side.

The graphics substrate may then be secured to a backer layer, which may be formed using a nylon tricot woven material, using an adhesive such as a hot melt film or other adhesive. This may be performed such that the non-smooth textured side of the graphics substrate forms an outer surface of the flexible material and the graphics are viewed through the graphics substrate. Thus, the graphics substrate may be utilized to protect the graphics from damage yet still support a desired non-smooth texture. Additionally, through use of a backer layer that is flexible, the flexible material may support inclusion of these graphics in configurations where flexibility is desired. Non-flexible configurations are also contemplated, such as through inclusion on a housing of a mobile computing device such as a mobile phone, tablet computer, portable game device, mouse, and so on. A variety of other examples are also contemplated, further discussion of which may be found in relation to the following sections.

In the following discussion, an example environment is first described that may employ the graphics and texture techniques described herein. Examples of layers that are usable in the example environment (i.e., the input device) are then described which may be performed in the example environment as well as other environments. Consequently, use of the example layers is not limited to the example environment and the example environment is not limited to use of the example layers.

### Example Environment

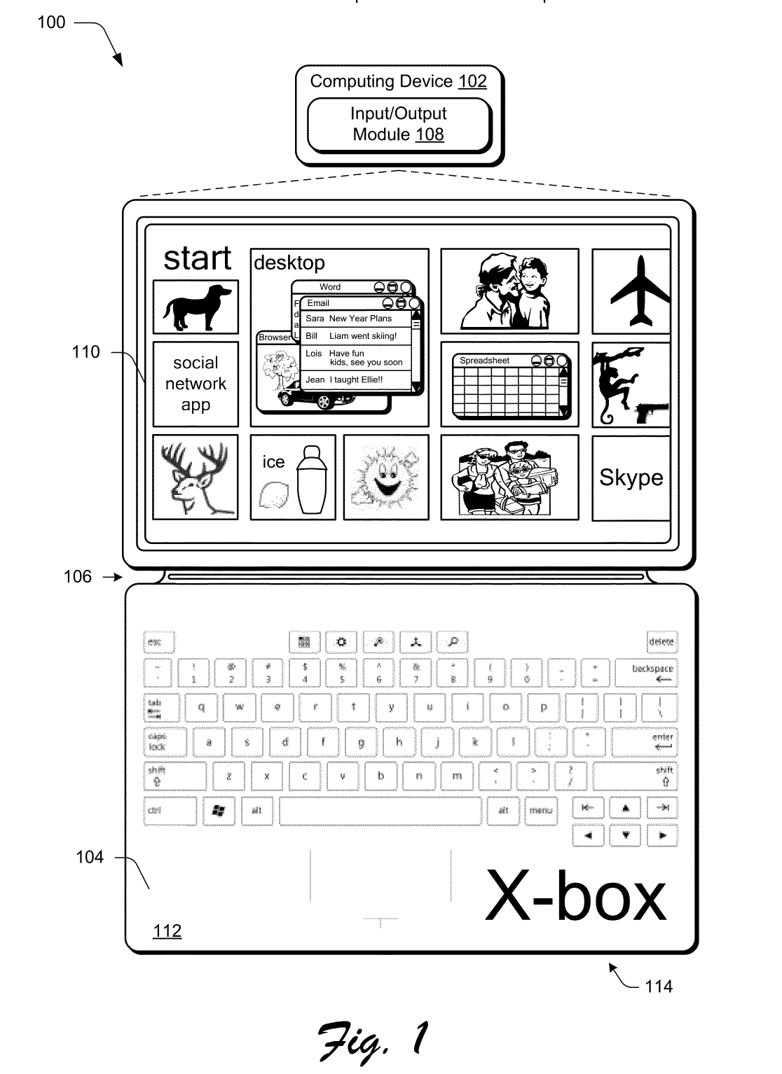

FIG. 1 is an illustration of an environment 100 in an example implementation that is operable to employ the texture and graphics formation techniques described herein. The illustrated environment 100 includes an example of a computing device 102 that is physically and communicatively coupled to an input device 104 via a flexible hinge 106. The computing device 102 may be configured in a variety of ways. For example, the computing device 102 may be configured for mobile use, such as a mobile phone, a tablet computer as illustrated, and so on that is configured to be held by one or more hands of a user. Thus, the computing device 102 may range from full resource devices with substantial memory and processor resources to a low-resource device with limited memory and/or processing resources. The computing device 102 may also relate to software that causes the computing device 102 to perform one or more operations.

The computing device 102, for instance, is illustrated as including an input/output module 108. The input/output module 108 is representative of functionality relating to processing of inputs and rendering outputs of the computing device 102. A variety of different inputs may be processed by the input/output module 108, such as inputs relating to functions that correspond to keys of the input device 104, keys of a virtual keyboard displayed by the display device 110 to identify gestures and cause operations to be performed that correspond to the gestures that may be recognized through the input device 104 and/or touchscreen functionality of the display device 110, and so forth. Thus, the input/output module 108 may support a variety of different input techniques by recognizing and leveraging a division between types of inputs including key presses, gestures, and so on.

In the illustrated example, the input device 104 is configured as having an input portion that includes a keyboard having a QWERTY arrangement of keys and track pad although other arrangements of keys are also contemplated. Further, other non-conventional configurations are also contemplated, such as a game controller, configuration to mimic a musical instrument, and so forth. Thus, the input device 104 and keys incorporated by the input device 104 may assume a variety of different configurations to support a variety of different functionality.

As previously described, the input device 104 is physically and communicatively coupled to the computing device 102 in this example through use of a flexible hinge 106. The flexible hinge 106 is flexible in that rotational movement supported by the hinge is achieved through flexing (e.g., bending) of the material forming the hinge as opposed to mechanical rotation as supported by a pin, although that embodiment is also contemplated. Further, this flexible rotation may be configured to support movement in one or more directions (e.g., vertically in the figure) yet restrict movement in other directions, such as lateral movement of the input device 104 in relation to the computing device 102. This may be used to support consistent alignment of the input device 104 in relation to the computing device 102, such as to align sensors used to change power states, application states, and so on.

The flexible hinge 106, for instance, may be formed using an outer layer 112 having one or more layers of fabric. The flexible hinge 106 includes conductors formed as flexible traces to communicatively couple the input device 104 to the computing device 102 and vice versa. This communication, for instance, may be used to communicate a result of a key press to the computing device 102, receive power from the computing device, perform authentication, provide supplemental power to the computing device 102, and so on.

In this example, the outer layer 112 continues from the flexible hinge 106 and covers at least a part of an input portion of the input device, e.g., by covering keys of the keyboard in a touch keyboard configuration, surrounding the keys in a mechanical type configuration, and so on. The outer layer 112 may also be disposed in a variety of other locations, such as a rear side of the input device 104, as part of a housing of the computing device 102, and so on.

Regardless of where the outer layer 112 is employed, techniques are described herein in which a graphic 114 may be included as part of the outer layer 112. Further, the graphic 114 may be included in a manner that maintains a texture (e.g., a non-smooth surface) and thus may be included as part of the input device 104 while preserving a look and feel of the device. Further discussion of techniques that may be utilized to form the texture and graphic may be found beginning in relation to FIG. 4.

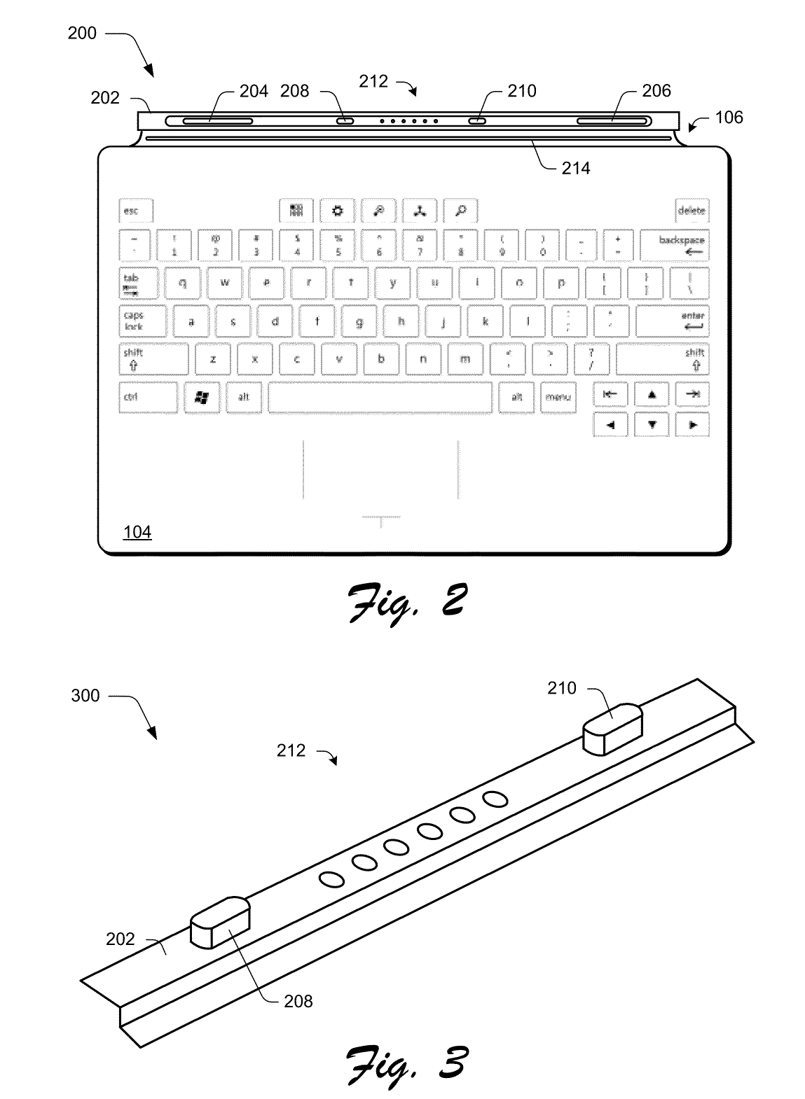

FIG. 2 depicts an example implementation 200 of the input device 104 of FIG. 1 as showing the flexible hinge 106 in greater detail. In this example, a connection portion 202 of the input device is shown that is configured to provide a communicative and physical connection between the input device 104 and the computing device 102. The connection portion 202 as illustrated has a height and cross section configured to be received in a channel in the housing of the computing device 102, although this arrangement may also be reversed without departing from the spirit and scope thereof.

The connection portion 202 is flexibly connected to a portion of the input device 104 that includes the keys through use of the flexible hinge 106. Thus, when the connection portion 202 is physically connected to the computing device 102 the combination of the connection portion 202 and the flexible hinge 106 supports movement of the input device 104 in relation to the computing device 102 that is similar to a hinge of a book.

Through this rotational movement, a variety of different orientations of the input device 104 in relation to the computing device 102 may be supported. For example, rotational movement may be supported by the flexible hinge 106 such that the input device 104 may be placed against the display device 110 of the computing device 102 and thereby act as a cover. Thus, the input device 104 may act to protect the display device 110 of the computing device 102 from harm.

The connection portion 202 may be secured to the computing device in a variety of ways, an example of which is illustrated as including magnetic coupling devices 204, 206 (e.g., flux fountains), mechanical coupling protrusions 208, 210, and a plurality of communication contacts 212. The magnetic coupling devices 204, 206 are configured to magnetically couple to complementary magnetic coupling devices of the computing device 102 through use of one or more magnets. In this way, the input device 104 may be physically secured to the computing device 102 through use of magnetic attraction.

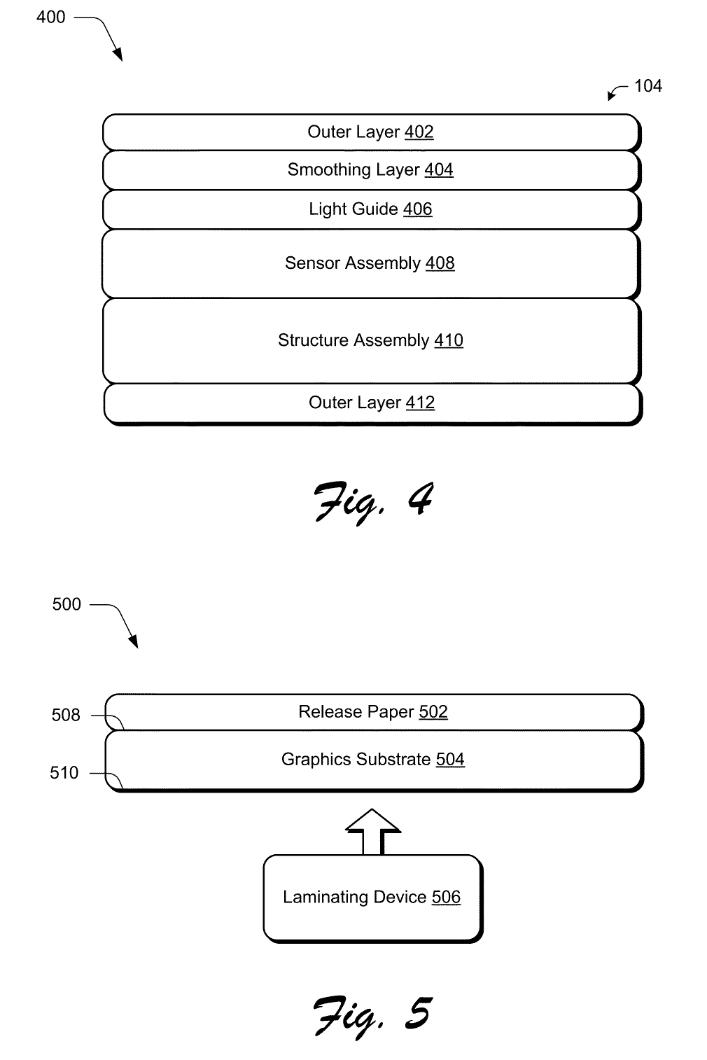

The connection portion 202 also includes mechanical coupling protrusions 208, 210 to form a mechanical physical connection between the input device 104 and the computing device 102. The mechanical coupling protrusions 208, 210 are shown in greater detail in relation to FIG. 3, which is discussed below.

FIG. 3 depicts an example implementation 300 showing a perspective view of the connection portion 202 of FIG. 2 that includes the mechanical coupling protrusions 208, 210 and the plurality of communication contacts 212. As illustrated, the mechanical coupling protrusions 208, 210 are configured to extend away from a surface of the connection portion 202, which in this case is perpendicular although other angles are also contemplated.

The mechanical coupling protrusions 208, 210 are configured to be received within complimentary cavities within the channel of the computing device 102. When so received, the mechanical coupling protrusions 208, 210 promote a mechanical binding between the devices when forces are applied that are not aligned with an axis that is defined as correspond to the height of the protrusions and the depth of the cavity.

The connection portion 202 is also illustrated as including a plurality of communication contacts 212. The plurality of communication contacts 212 is configured to contact corresponding communication contacts of the computing device 102 to form a communicative coupling between the devices as shown. The connection portion 202 may be configured in a variety of other ways, including use of a rotational hinge, mechanical securing device, and so on. In the following, an example of a docking apparatus 112 is described and shown in a corresponding figure.

FIG. 4 depicts an example implementation 400 showing a cross section of input device 104 of FIG. 1. The outer layer 402 is configured to supply an outer surface of the input device 104 with which a user may touch and interact, like the outer layer 112 of FIG. 1. The outer layer 402 may be formed in a variety of ways, such as from a fabric material, e.g., a backlight compatible polyurethane with a heat emboss for key formation.

Beneath the outer layer is a smoothing layer 404 in this example. The smoothing layer 404 may be configured to support a variety of different functionality. This may include use as a support to reduce wrinkling of the outer layer 402, such as through formation as a thin plastic sheet, e.g., approximately 0.125 millimeters of polyethylene terephthalate (PET), to which the outer layer 402 is secured through use of an adhesive. The smoothing layer 404 may also be configured to including masking functionality to reduce and even eliminate unwanted light transmission, e.g., “bleeding” of light through the smoothing layer 404 and through a fabric outer layer 402. The smoothing layer also provides a continuous surface under the outer layer, such that it hides any discontinuities or transitions between the inner layers.

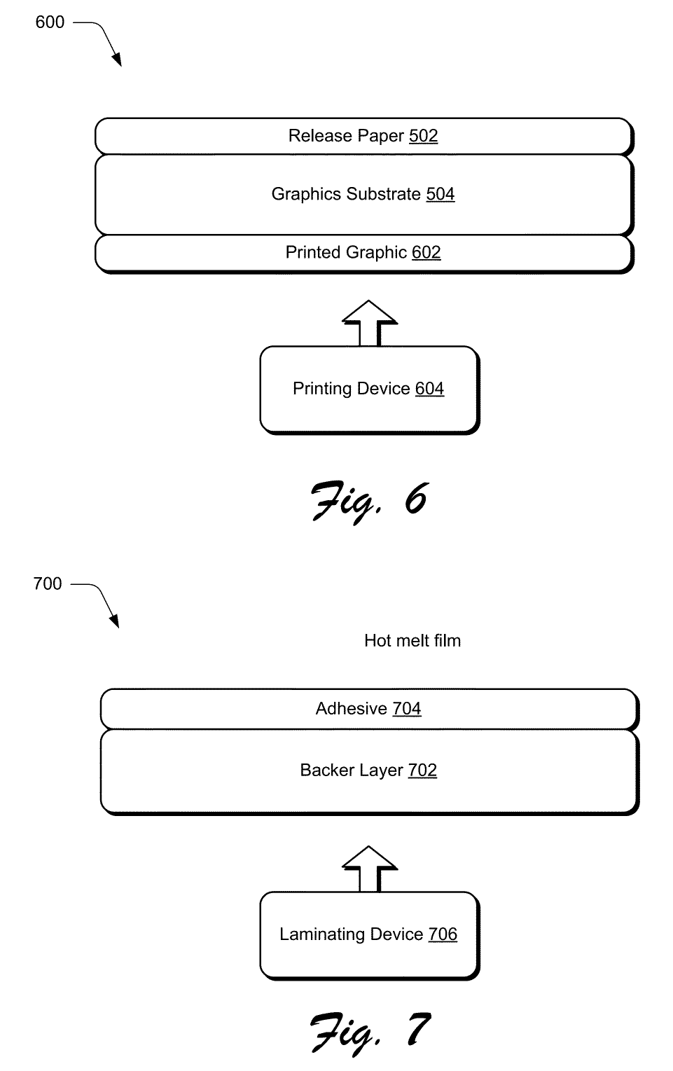

A light guide 406 is also illustrated, which may be included as part of the backlight mechanism 112 of FIG. 2 to support backlighting of indications (e.g., legends) of inputs of the input device 104. This may include illumination of keys of a keyboard, game controls, gesture indications, and so on. The light guide 406 may be formed in a variety of ways, such as from a 250 micron thick sheet of a plastic, e.g., a clear polycarbonate material with etched texturing. Additional discussion of the light guide 406 may be found beginning in relation to FIG. 5.

A sensor assembly 408 is also depicted. Thus, as illustrated the light guide 406 and the smoothing layer 404 are disposed between the outer layer 402 and the sensor assembly 408. The sensor assembly 408 is configured detect proximity of an object to initiate an input. The detected input may then be communicated to the computing device 102 (e.g., via the connection portion 202) to initiate one or more operations of the computing device 102. The sensor assembly 408 may be configured in a variety of ways to detect proximity of inputs, such as a capacitive sensor array, a plurality of pressure sensitive sensors (e.g., membrane switches using a pressure sensitive ink), mechanical switches, a combination thereof, and so on.

A structure assembly 410 is also illustrated. The structure assembly 410 may be configured in a variety of ways, such as a trace board and backer that are configured to provide rigidity to the input device 104, e.g., resistance to bending and flexing. An outer layer 412 is also illustrated as providing a rear surface to the input device 104 and thus may also correspond to an outer layer 112 of FIG. 1. The outer layer 412, for instance, may be formed from a fabric similar to an outer layer 402 that omits one or more sub-layers of the outer layer 402, e.g., a 0.38 millimeter thick fabric made of wet and dry layers of polyurethane. Although examples of layers have been described, it should be readily apparent that a variety of other implementations are also contemplated, including removal of one or more of the layers, addition of other layers (e.g., a dedicated force concentrator layer, mechanical switch layer), and so forth. Thus, the following discussion of examples of layers is not limited to incorporation of those layer in this example implementation 400 and vice versa.

FIGS. 5-9 depict example implementations of formation of an outer layer 112 to include graphics as part of the layer. Textured materials such as synthetic fabric materials are abundant in consumer electronics as part of a cover for the device, as part of the device itself, parts that are to be contacted by a user (e.g., ears of a user as part of headphones, grasped by one or more hands of a user), and so forth.

As previously described, conventional techniques that are utilized to form graphics on a textured surface failed to protect the graphics from wear and abrasion, had limited resolution, and so on. For example, previous solutions often involved printing of the graphic on the surface of the fabric with increased bond strength of the ink to the textured surface, e.g., fabric. Spray on over-coating methods have also been used to protect the graphic. Another technique involves laser cutting to selectively remove a top layer of material to expose a lower layer of a different color. Although this last technique is durable this technique limits the number of colors available as part of the graphic. Location of the graphic on the final product may also be a challenge using conventional techniques as printing or application of the graphic to the fabric is best done before the fabric is added to the assembly. But cutting variation and fabric shrinkage can lead to inaccurate placement of the graphic on the final product.

Accordingly, techniques are shown and described in relation to the example implementations 500-900 of FIGS. 5-9 such that a graphic is formed as part of an outer layer having a texture and yet is protected from wear and abrasion. For example, a graphic may be printed to an underside of a graphics substrate that is formed using a generally clear or translucent material. The graphics substrate is then bonded to a backer layer, such as a woven material to keep the graphic visible while “inside” the flexible material formed by the graphics substrate and woven material.

Additionally, the graphics substrate may be configured to have two sides having different textures. A generally smooth side may be configured to include the graphic, e.g., by being printed thereon. Additionally, a non-smooth (e.g., textured) side of the graphic substrate may also be included to provide an outer surface that is configured to be touched by a user, and thus may avoid a slick plastic feel to the outer layer. Thus, this technique supports independent control of the smoothness of the printed surface (which will become the inside surface) and the outside surface. By integrating the graphic into the construction of the material itself of the outer layer, the overall thickness may be minimized thereby allowing for a thin and flexible final product.

Further, the graphic may be located as part of final assembly of a device (e.g., cover, electronics device, computing device, peripheral device, and so on) through use of printed datums. The datums, for instance, may be cut into physical features using a CNC machine with an optical feedback mechanism. In this way, the image location on the final assembly may be controlled with sufficient precision. Further discussion of these techniques may be found in the following.

FIG. 5 depicts an example implementation 500 of a system usable to form a graphics substrate of an outer layer 112 of FIG. 1. This implementation 500 includes a release paper 502, a graphics substrate 504, and a laminating device 506. The laminating device 506 is this example is configured to form the graphics substrate 504 by performing one or more laminations of a generally transparent material, such as a clear polyurethane also known as a “Dry PU.” For example, multiple laminations may be performed by the laminating device 506 to achieve a thickness of approximately 75 to 105 micrometers.

The release paper 502 is configured to supply a desired texture to these laminations. For example, the release paper 502 may be configured to mimic a desired texture, such as a fabric texture, woven texture, leather-like feel, and so on. In this way, the release paper 502 may provide a roughness to an outer surface 508 of the graphics substrate 504 supporting a desired feel to the graphics substrate 502.

Further, the graphics substrate 504 may include a generally smooth surface 510 and thus provide a surface suitable for forming a graphic, e.g., through printing as further described below. Thus, in this example the graphics substrate 504 includes an outer surface 508 having a non-smooth surface and a generally smooth surface 510 disposed on an opposing side of the outer surface 508 having the texture.

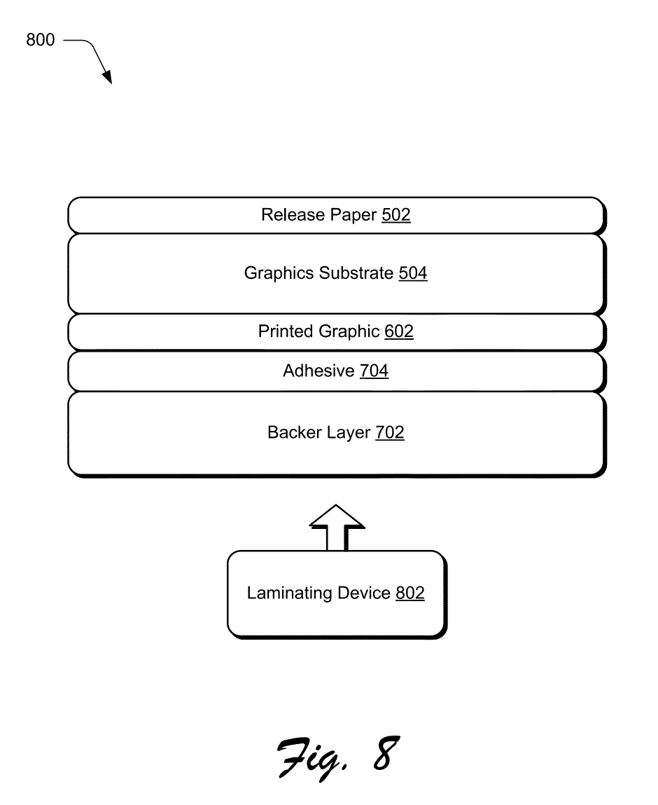

FIG. 6 depicts an example implementation 600 of a system usable to form graphics on the graphics substrate formed in FIG. 5. Graphics 114 of FIG. 1 may be formed are part of a graphics substrate in a variety of ways. For example, the graphics 114 may be formed as an integral part of the material used to form the graphics substrate 504 such that the substrate itself supplies the graphic 114.

The graphics 114 may also be formed on the graphics substrate 504. For example, the graphics substrate 504 may be formed as described in relation to FIG. 5 on the release paper 502 by lamination. As such, a side of the graphics substrate 504 opposite the release paper 502 may be generally smooth and therefore configured to efficiently receive a graphic with good resolution.

As illustrated in the example implementation 600 of FIG. 6, for instance, a printed graphic 602 may be formed on the graphics substrate 504 by a printing device 604. Therefore, the printed graphic 602 may include a variety of colors and techniques that may be printed. Further, as the printed graphic 602 is disposed on a side of the graphics substrate 504 that is opposite to an outer surface adjacent to the release paper 502, the printed graphic 602 may be protected from abrasion and wear by the graphics substrate 504. Printing of the printed graphic 602 may be performed by the printing device 604 as a mirror image of how the graphic is intended to be viewed because the printed graphic 602 is to be viewed through the graphics substrate 504. The graphics substrate 504 may be attached to a backer layer, an example of formation of which is described as follows and shown in a corresponding figure.

FIG. 7 depicts an example implementation 700 of a system usable to form a backer layer and adhesive of an outer layer 112 of FIG. 1. As previously described the texture and graphic techniques may be utilized for inclusion on a variety of different surfaces as part of a variety of different devices, such as a housing of a computing device, cover for a computing device, part of an input or output device, and so on.

As such, the backer layer 702 may be configured in a variety of different ways. For example, the back layer 702 may be configured to support flexibility of the outer layer 112 as a whole and thus may be flexible. An example of such a material is a woven material, such as a woven nylon tricot weave that is approximately 250 microns thick, from a polyurethane (PU) material such as a dry PU skin, and so on. Other non-flexible implementations are also contemplated, such as use of a housing of the computing device 102 as a backer layer 702.

An adhesive 704 is formed on the backer layer 702 in this example. The adhesive may assume a wide variety of configurations and as such may be formed in a wide variety of ways. As illustrated, for instance, a laminating device 706 may be employed to laminate the adhesive 704 as a hot melt film, which is also referred to as a heat activated film. For example, a high temperature hot melt film may be used that does not weaken during future thermal cycles. Other liquid, powder, and other adhesive and securing techniques (e.g., mechanical) are also contemplated.

The adhesive 704, in one or more implementations, may be configured to control how (if at all) the backer layer 702 is viewable to a user. For example, the backer layer may be configured as a white tricot woven Nylon and the adhesive 704 may be configured to include a pigment (e.g., fifty percent white pigment) that is viewable through the graphics substrate 504 and graphic 602 such that the adhesive 704 is opaque. Other pigments and arrangements thereof are also contemplated. For instance, the backer layer 702 may be viewed, at least partially, through the adhesive 704. In such instances the adhesive 704 may be formed as least partially transparent, may be translucent to provide a desired color that is viewable for the backer layer 702, and so on.

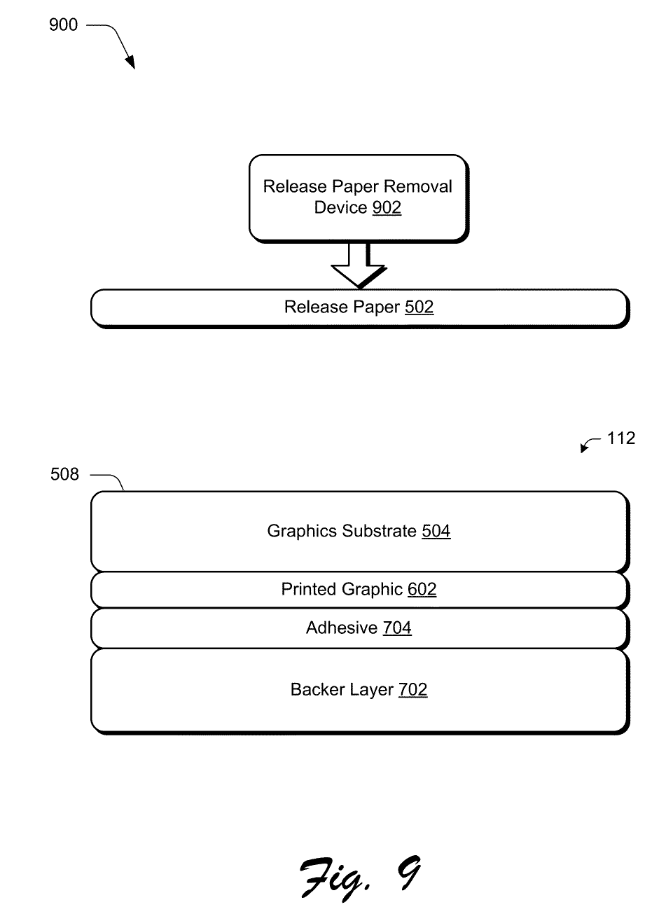

FIG. 8 depicts an example implementation 800 showing a system usable to form the outer layer 112 of FIG. 1 using the graphics substrate 504 having the printed graphics 602 of FIG. 6 with the backer layer and adhesive of FIG. 7. A laminating device 802 is utilized in this example to cause the adhesive 702 to secure the graphics substrate 504 to the backer layer 702, e.g., through use of a sufficient temperature to cause melting of the hot melt film of the adhesive 704. Other examples are also contemplated depending on the configuration of the adhesive 704, backer layer 702, and so on. For example, use of the adhesive 704 in a liquid form may be applied to attach the backer layer 702 to the graphics substrate 504, e.g., in a non-flexible configuration.

FIG. 9 depicts an example implementation 900 showing a system usable to remove the release paper 502 to expose an outer surface 508 of the outer layer 112 formed in FIG. 8. A release paper removal device 902 is illustrated in this example as removing the release paper 502. Thus, an outer surface 508 having a texture caused by the release paper 502 is exposed for use as part of a device, e.g., a cover, input device 104, computing device 102, and so on.

In this way, a texture of the outer surface 508 is protected during the manufacture of the outer layer 112 from damage and so on. A variety of other examples are also contemplated, such as to remove the release paper at a previous stage in the manufacture of the outer layer 112. Thus, through use of these techniques a relatively thin (e.g., approximately 0.5 millimeter) outer layer 112 may be formed that is textured and includes graphics that are protected from wearing and abrasion. Further, this texture and graphic may be incorporated on a variety of different types of devices and apparatus.

### Example System and Device

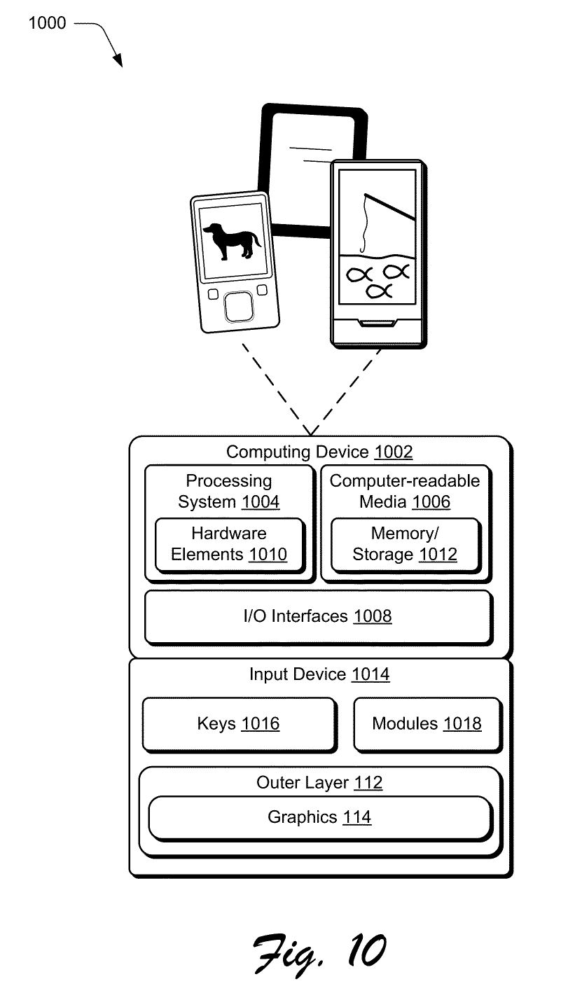

FIG. 10 illustrates an example system generally at 1000 that includes an example computing device 1002 that is representative of one or more computing systems and/or devices that may implement the various techniques described herein. The computing device 1002 may be, for example, be configured to assume a mobile configuration through use of a housing formed and size to be grasped and carried by one or more hands of a user, illustrated examples of which include a mobile phone, mobile game and music device, and tablet computer although other examples are also contemplated. The input device 1014 may also be configured to include an outer layer 112 and graphics 114 as previously described. So too may an external enclosure of the computing device, e.g., a housing 1002.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media. The memory/storage component 1010 may include volatile media (such as random access memory (RAM)) and/or nonvolatile media (such as read only memory (ROM), Flash memory, optical disks, magnetic disks, and so forth). The memory/storage component 1010 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways to support user interaction.

The computing device 1002 is further illustrated as being communicatively and physically coupled to an input device 1014 that is physically and communicatively removable from the computing device 1002. In this way, a variety of different input devices may be coupled to the computing device 1002 having a wide variety of configurations to support a wide variety of functionality. In this example, the input device 1014 includes one or more keys 1016, which may be configured as pressure sensitive keys, mechanically switched keys, and so forth.

The input device 1014 is further illustrated as include one or more modules 1018 that may be configured to support a variety of functionality. The one or more modules 1018, for instance, may be configured to process analog and/or digital signals received from the keys 1016 to determine whether a keystroke was intended, determine whether an input is indicative of resting pressure, support authentication of the input device 1014 for operation with the computing device 1002, and so on.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. An apparatus comprising:
one or more modules implemented at least partially in hardware, the one or more modules configured to perform operations as part of a computing device; and
an outer layer disposed over and at least partially covering the one or more modules, the outer layer includes a graphics substrate having an outer surface that has a non-smooth texture and one or more graphics formed on an opposing side of the graphics substrate from the outer surface.

2. An apparatus as described in claim 1, wherein the graphics substrate is configured to be at least partially transparent such that the one or more graphics are viewable through the graphics substrate.

3. An apparatus as described in claim 1, wherein the graphics substrate is formed by laminating a material on release paper such that the graphics substrate includes the non-smooth texture and also has a generally smooth texture on the opposing side of the graphics substrate that is configured to include the one or more graphics.

4. An apparatus as described in claim 3, wherein the material is a polyurethane.

5. An apparatus as described in claim 1, wherein the non-smooth texture is configured to mimic a feeling of leather, a woven material, or a fabric.

6. An apparatus as described in claim 1, wherein the outer layer further comprises a backer layer that is secured to the graphics substrate.

7. An apparatus as described in claim 6, wherein the backer layer is configured as a flexible woven backer such that the graphics substrate is configured to support flexing while secured to the backer layer.

8. An apparatus as described in claim 6, wherein the backer layer is secured to the graphics layer using an adhesive.

9. An apparatus as described in claim 6, wherein the adhesive includes a sufficient quantity of pigment such that the backer layer is not viewable through the adhesive.

10. An apparatus as described in claim 1, further comprising a connection portion configured to form a communicative and physical coupling to the computing device that is removable using one or more hands of a user.

11. An apparatus as described in claim 10, further comprising an input portion that is communicatively coupled to the connection portion and configured to provide inputs via the connection portion to the computing device.

12. An apparatus as described in claim 1, further comprising a housing of the computing device that is configured to include the one or more modules therein and has attached thereto the outer layer to form at least part of an outer surface of the computing device.

13. An apparatus as described in claim 12, wherein the housing is configured according to a mobile form factor that is configured to be grasped by one or more hands of a user.

14. An input device comprising:
a plurality of sensors configured to generate one or more inputs though user interaction;
a connection portion configured to provide a physical and communicative coupling to a computing device, the communicative coupling configured to communicate the one or more inputs from the plurality of sensors to the computing device; and
an outer layer providing at least a portion of an outer surface of the input device, the outer layer includes a flexible graphics substrate having one or more graphics that are viewable through the flexible graphics substrate, the flexible graphics substrate is secured to a backer layer formed using a woven material.

15. An input device as described in claim 14, wherein the connection portion is configured to be physically secured to the computing device using magnetism.

16. An input device as described in claim 14, wherein the flexible graphic substrate is formed at least in part using polyurethane.

17. An input device as described in claim 14, wherein the outer surface provided by the flexible graphics substrate of the outer layer has a non-smooth surface formed through use of a release paper having a texture.

18. A flexible material having graphics comprising:
a graphics substrate having an outer surface having a non-smooth texture and the graphics formed on an opposing side of the graphics substrate from the outer surface; and
a backer layer formed from a flexible woven material that is secured to the graphics substrate using an adhesive such that the graphics substrate and the backer layer are flexible when secured to each other.

19. A flexible material as described in claim 18, wherein the graphics are printed on the opposing side of the graphics substrate, which is smoother than the non-smooth texture of the outer surface of the graphics substrate.

20. A flexible material as described in claim 18, wherein the non-smooth texture is configured by laminating polyurethane that forms the graphics substrate on a release paper.
